(19) United States
(12) Patent Application Publication
(10) Pub. No.: US 2024/0151833 A1
(43) Pub. Date: May 9, 2024

(54) SENSOR ASSEMBLY WITH DUCT

(71) Applicant: Ford Global Technologies, LLC, Dearborn, MI (US)

(72) Inventors: Venkatesh Krishnan, Canton, MI (US); Sunil Reddy Patil, Troy, MI (US); Michael Robertson, JR., Garden City, MI (US); Rashaun Phinisee, Ypsilanti, MI (US); Anthony Michael Regalbuto, Highland, MI (US); Kunal Chaudhari, Westland, MI (US); Mallikarjun Sukumar, Chennai (IN)

(73) Assignee: Ford Global Technologies, LLC, Dearborn, MI (US)

(21) Appl. No.: 18/052,947

(22) Filed: Nov. 7, 2022

(51) Int. Cl. G01S 7/497; B60S 1/54; G01S 7/481; G01S 17/931

(52) U.S. Cl. CPC G01S 7/497; B60S 1/54; G01S 7/4813; G01S 17/931; G01S 2007/4977

(57) ABSTRACT

A sensor assembly includes a housing defining a chamber and having an air inlet. A blower is disposed in the chamber and is in fluid communication with the air inlet. The blower is positioned to direct air in a flow direction. A sensor is disposed in the chamber and has a lens. The sensor is spaced from the blower. An air nozzle is aimed to direct air across the lens. A duct is disposed in the chamber and is coupled to the blower and the air nozzle. The duct extends from the blower in a departure direction oblique to the flow direction.

### BACKGROUND

Autonomous vehicles typically include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back. When sensor lenses, covers, and the like become dirty, smudged, etc., sensor operation can be impaired or precluded.

### BRIEF DESCRIPTION OF THE DRAWINGS

FIG. 1 is a perspective view of a vehicle including an example sensor assembly mounted to a roof.

FIG. 2 is an exploded view of the sensor assembly including a housing lower piece and a housing upper piece.

FIG. 3 is a rear perspective view of the sensor assembly on the vehicle.

FIG. 4 is a top view of the housing lower piece.

FIG. 5 is a cross-sectional view along line 5 in FIG. 3.

FIG. 6A is a perspective view of an air nozzle directing air across a lens of a sensor.

FIG. 6B is a perspective view of a fluid nozzle directing fluid across the lens of the sensor.

FIG. 7 is a diagram of an example cleaning system of the vehicle.

### DETAILED DESCRIPTION

A sensor assembly includes a housing defining a chamber and having an air inlet. A blower is disposed in the chamber and is in fluid communication with the air inlet. The blower is positioned to direct air in a flow direction. A sensor is disposed in the chamber and has a lens. The sensor is spaced from the blower. An air nozzle is aimed to direct air across the lens. A duct is disposed in the chamber and is coupled to the blower and the air nozzle. The duct extends from the blower in a departure direction oblique to the flow direction.

The sensor assembly may include a fluid nozzle aimed to direct fluid across the lens.

The fluid nozzle may be is circumferentially spaced from the air nozzle about the lens.

The fluid nozzle may be oblique to the air nozzle. The fluid nozzle may be shaped to spray fluid in a flat-fan pattern. The air nozzle may be shaped to discharge air in a flat-fan pattern.

The air nozzle may be shaped to discharge air in a flat-fan pattern.

The duct may extend transverse to the flow direction at the nozzle.

The sensor assembly may include a second sensor disposed in the chamber and having a second lens. The second sensor may be spaced from the sensor and the blower. A second air nozzle may be aimed to direct air across the second lens. A second duct may be disposed in the chamber and may extend from the blower to the second air nozzle. The second duct may be coupled to the blower and the second air nozzle. The second duct may extend from the blower in a second departure direction oblique to the flow direction and transverse to the departure direction.

A vehicle includes a roof and a housing supported by the roof. The housing defines a chamber and has an air inlet. A blower is disposed in the chamber and is in fluid communication with the air inlet. The blower is positioned to direct air in a flow direction. A sensor is disposed in the chamber and has a lens. The sensor is spaced from the blower. An air nozzle is aimed to direct air across the lens. A duct is disposed in the chamber and is coupled to the blower and the air nozzle. The duct extends from the blower in a departure direction oblique to the flow direction.

The vehicle may include a fluid nozzle aimed to direct fluid across the lens. The fluid nozzle may be circumferentially spaced from the air nozzle about the lens. The fluid nozzle may be oblique to the air nozzle. The fluid nozzle may be aimed to direct fluid generally parallel to ambient airflow during forward motion of the vehicle. The air nozzle may be aimed to direct air generally parallel to ambient airflow during forward motion of the vehicle.

The air nozzle may be aimed to direct air generally parallel to ambient airflow during forward motion of the vehicle.

The duct may extend transverse to the flow direction at the nozzle.

The vehicle may include a second sensor disposed in the chamber and having a second lens. The second sensor may be spaced from the sensor and the blower. A second air nozzle may be aimed to direct air across the second lens. A second duct may be disposed in the chamber and may extend from the blower to the second air nozzle. The second duct may be coupled to the blower and the second air nozzle. The second duct may extend from the blower in a second departure direction oblique to the flow direction and transverse to the departure direction.

With reference to the Figures, wherein like numerals indicate like parts throughout the several views, a sensor assembly 12 for a vehicle 10 includes a housing 14 defining a chamber 16 and having an air inlet 18. A blower 20 is disposed in the chamber 16 and is in fluid communication with the air inlet 18. The blower 20 is positioned to direct air in a flow direction F. A sensor 22 is disposed in the chamber 16 and has a lens 24. The sensor 22 is spaced from the blower 20. An air nozzle 26 is aimed to direct air across the lens 24. A duct 28 is disposed in the chamber 16 and is coupled to the blower 20 and the air nozzle 26. The duct 28 extends from the blower 20 in a departure direction D oblique to the flow direction F.

The sensor assembly 12 uses fluid for cleaning the lens 24 of the sensor 22, which can improve the quality of data gathered by the sensor 22. Additionally, the sensor assembly 12 uses air for cleaning and/or drying the lens 24 of the sensor 22, e.g., by pushing debris and/or liquid droplets off the sensor 22. Advantageously, the duct 28 extends from the blower 20 to the air nozzle 26 and is coupled to the blower 20 and the air nozzle 26, which maintains pressure within the duct 28. Maintaining the pressure between the blower 20 and the air nozzle 26 allows air to exit the air nozzle 26 at a velocity sufficient to clean and/or dry the lens 24 of the sensor 22. Additionally, the duct 28 is oblique to the blower 20 at the blower 20, which can satisfy packaging constraints within the chamber 16 while minimizing flow loss through the duct 28. Being oblique to the blower 20 at the blower 20 allows the duct 28 to reduce flow loss through the duct 28 as compared to a duct that extends perpendicular to a blower at the blower. The duct 28 may extend at any suitable oblique angle relative to the blower 20. That is, the duct 28 may extend at any one of several different oblique angles relative to blower 20 to minimize flow loss through the duct 28 based on the duct 28 being disposed in one of several locations with the chamber 16 and packaging constraints associated with the respective location.

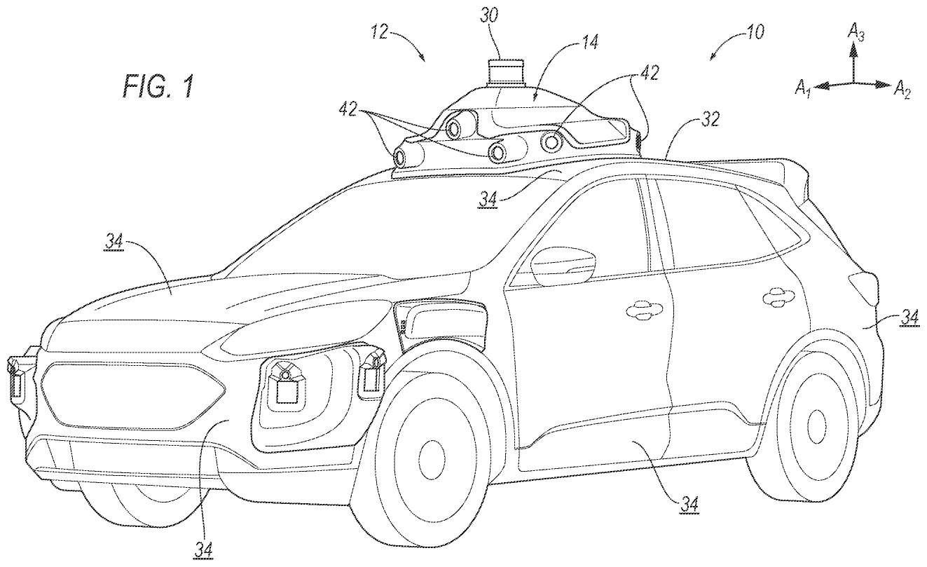

With reference to FIG. 1, the vehicle 10 may be any passenger or commercial automobile such as a car, a truck, a sport utility vehicle, a crossover, a van, a minivan, a taxi, a bus, etc.

The vehicle 10 defines a longitudinal axis A₁, e.g., extending between a front and a rear of the vehicle 10. The vehicle 10 defines a lateral axis A₂, e.g., extending between a left side and a right side of the vehicle 10. The vehicle 10 defines a vertical axis A₃, e.g., extending between a top and a bottom of the vehicle 10. The longitudinal axis A₁, the lateral axis A₂, and the vertical axis A₃ are perpendicular to each other.

The vehicle 10 may be an autonomous or semi-autonomous vehicle. A vehicle computer can be programmed to operate the vehicle 10 independently of the intervention of a human driver, completely or to a lesser degree. The vehicle computer may be programmed to operate a propulsion, brake system, steering, and/or other vehicle systems based at least in part on data received from one or more sensors 22, as well as a scanning sensor 30 described below. For the purposes of this disclosure, autonomous operation means the vehicle computer controls the propulsion, brake system, and steering without input from a human driver; semi-autonomous operation means the vehicle computer controls one or two of the propulsion, brake system, and steering and a human driver controls the remainder; and nonautonomous operation means a human driver controls the propulsion, brake system, and steering.

The vehicle 10 includes a body 32. The vehicle 10 may be of a unibody construction, in which a frame and the body 32 of the vehicle 10 are a single component. The vehicle 10 may, alternatively, be of a body-on-frame construction, in which the frame supports the body 32 that is a separate component from the frame. The frame and body 32 may be formed of any suitable material, for example, steel, aluminum, etc.

The body 32 includes body panels 34 partially defining an exterior of the vehicle 10. The body panels 34 may present a class-A surface, e.g., a finished surface exposed to view by a customer and free of unaesthetic blemishes and defects. The body panels 34 include, e.g., a roof, etc.

The housing 14 is attachable to the vehicle 10, e.g., to one of the body panels 34 of the vehicle 10, e.g., the roof. The sensors 22 and the scanning sensor 30 are supported by and/or disposed in the housing 14. The housing 14 may be shaped to be attachable to the roof, e.g., may have a shape matching a contour of the roof. The housing 14 may be attached to the roof, which can provide the sensors 22 and the scanning sensor 30 with an unobstructed field of view of an area around the vehicle 10. The housing 14 may be formed of, e.g., plastic or metal.

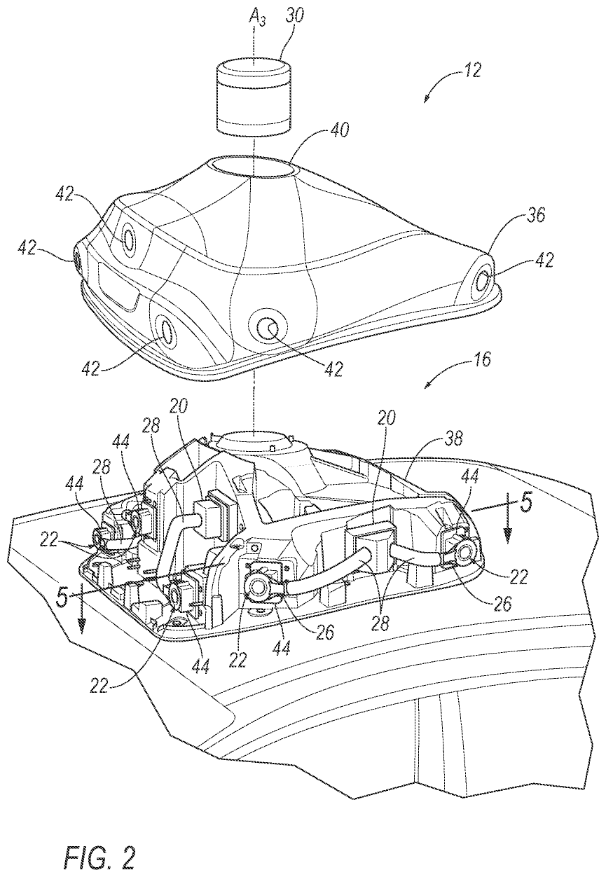

With reference to FIG. 2, the housing 14 includes a housing upper piece 36 and a housing lower piece 38. The housing upper piece 36 and the housing lower piece 38 are shaped to fit together, with the housing upper piece 36 fitting on top of the housing lower piece 38. The housing upper piece 36 covers the housing lower piece 38. The housing 14 may enclose and define the chamber 16; for example, the housing upper piece 36 and the housing lower piece 38 may enclose and define the chamber 16. The housing 14 may shield contents of the chamber 16 from external elements such as wind, rain, debris, etc.

The housing upper piece 36 includes a central opening 40 that exposes the housing lower piece 38. The central opening 40 is round, e.g., has a circular or slightly elliptical shape. The housing upper piece 36 and the housing lower piece 38 are each monolithic. For the purposes of this disclosure, “monolithic” means a single-piece unit, i.e., a continuous piece of material without any fasteners, joints, welding, adhesives, etc., fixing multiple pieces to each other. For example, the housing upper piece 36 and the housing lower piece 38 may be stamped or molded as a single piece.

With continued reference to FIG. 2, the housing upper piece 36 may include apertures 42. The apertures 42 are holes in the housing upper piece 36 leading from the chamber 16 into the ambient environment. That is, the apertures 42 extend through the housing upper piece 36. The apertures 42 may be any suitable shape, e.g., circular. The housing upper piece 36 includes one aperture 42 for each sensor 22. Each sensor 22 has a field of view received through the respective aperture 42. For example, the sensors 22 may extend into the respective apertures 42. In such an example, the aperture 42 may be concentric about a portion of the sensor 22, e.g., the lens 24.

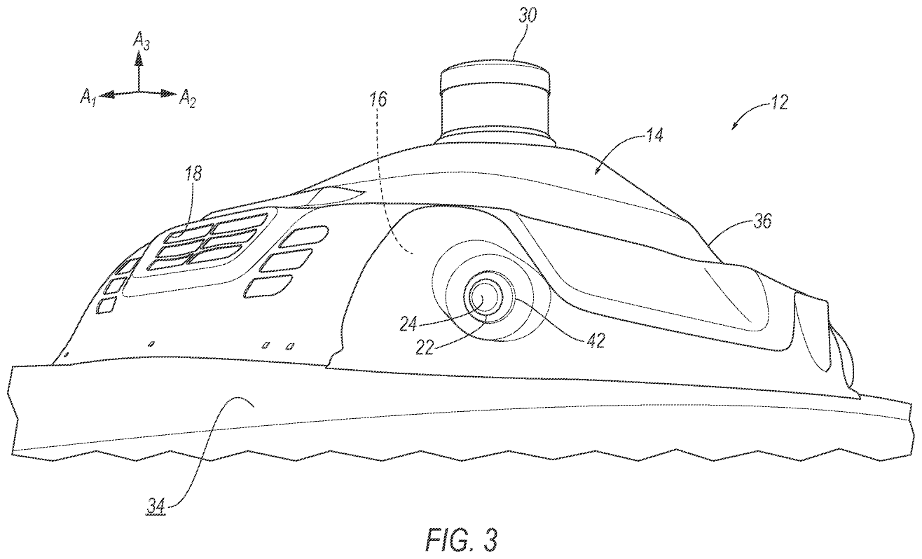

With reference to FIG. 3, the housing upper piece 36 may include the air inlet 18. The air inlet 18 permits air to enter the chamber 16 of the housing 14. The air inlet 18 may include an opening through which air may travel, baffles that direct the air, and/or other suitable structure. The air inlet 18 may be open to the external environment. The air inlet 18 may be in fluid communication with the chamber 16, i.e., such that air may flow from outside the chamber 16, through the air inlet 18, and into the chamber 16. The air inlet 18 may include a filter (not shown). The filter removes solid particulates such as dust, pollen, mold, dust, and bacteria from air flowing through the filter. The filter may be any suitable type of filter, e.g., paper, foam, cotton, stainless steel, oil bath, etc. The air inlet 18 may face any direction relative to forward travel of the vehicle 10. For example, the air inlet 18 may face vehicle-rearward. As another example, the air inlet 18 may face vehicle-forward, e.g., such that ram air entering the air inlet 18 pressurizes the chamber 16. The housing upper piece 36 may include any suitable number of air inlets 18, i.e., one or more.

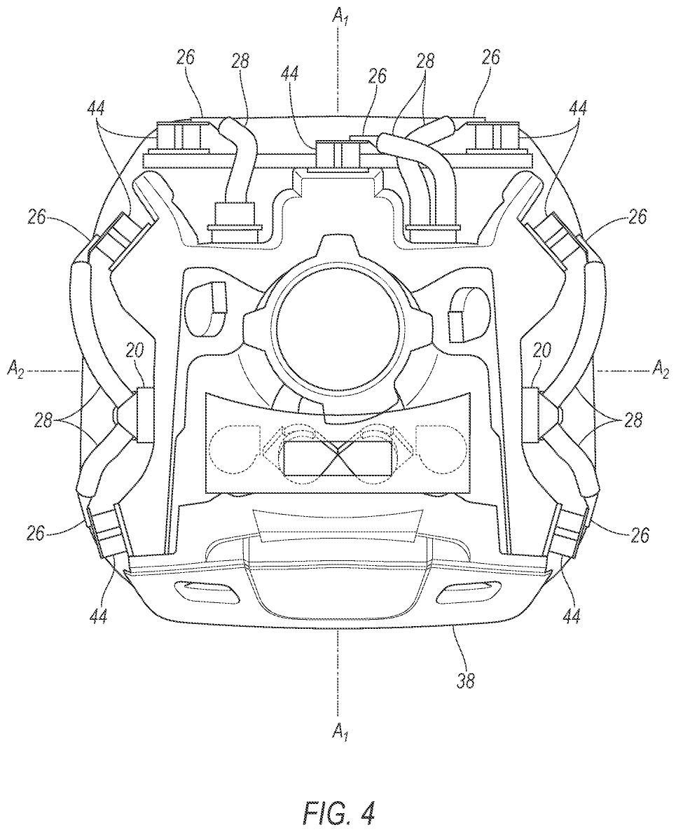

With reference to FIG. 4, the blower 20 is supported by the housing lower piece 38. For example, the blower 20 may be mounted to the housing lower piece 38. For example, the blower 20 may include locating elements, fasteners, etc., that engage the housing lower piece 38. Additionally, or alternatively, fasteners may engage the blower 20 and the housing lower piece 38 to mount the blower 20 to the housing lower piece 38. The sensor assembly 12 may include any suitable number of blowers 20.

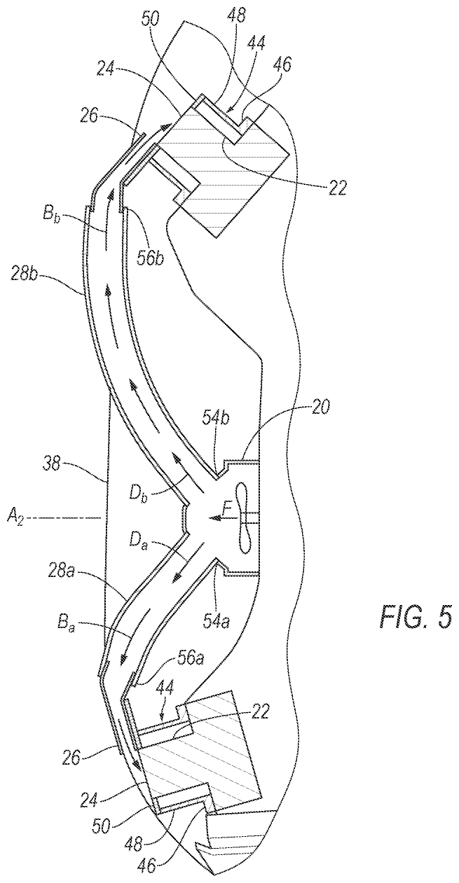

The blower 20 may include an electric motor, a fan, or other suitable structure for moving air. The blower 20 moves air in a flow direction F, e.g., between an intake and an exhaust, as shown in FIG. 5. The blower 20 may be configured to draw air via the intake and exhaust air via the exhaust in the flow direction F. The intake of the blower 20 is in fluid communication with the air inlet 18, and the exhaust of the blower 20 is in fluid communication with the duct 28. That is, the blower 20 pulls air from the chamber 16 and urges air to flow out of the exhaust in the flow direction F, through the duct 28, to (and out of) the air nozzle 26, and across the lens 24 of the sensor 22.

The blower 20 may be coupled to and in fluid communication with any suitable number of ducts 28, e.g., one or more. As one example, the blower 20 may be coupled to and in fluid communication with one duct 28. In such an example, the blower 20 may blow air into the duct 28, e.g., such that the blower 20 creates a positive pressure in the duct 28. As another example, the blower 20 may be coupled to and in fluid communication with two ducts 28, as shown in FIG. 5. In such an example, the blower 20 may blow air into both ducts 28, e.g., such that the blower 20 creates a positive and equal pressure in the two ducts 28.

The sensor assembly 12 may include any suitable number of blowers 20. For example, the sensor assembly 12 may include one blower 20 for each sensor 22. In such an example, each blower 20 may blow air across one respective sensor 22. As another example, the sensor assembly 12 may include fewer blowers 20 than sensors 22, as shown in FIGS. 2 and 4. In such an example, at least some of the blowers 20 may blow air across a respective plurality of sensors 22.

With reference to FIG. 5, the duct 28 receives air from the blower 20, e.g., the exhaust, and directs air to the air nozzle 26. The duct 28 is disposed in the chamber 16. The duct 28 may be supported by the housing 14, as shown in FIGS. 2, 4 and 5. For example, the duct 28 may be fixed to the housing lower piece 38, e.g., via fasteners, clips, adhesives, etc.

The duct 28 extends from a first end 54 to a second end 56, as shown in FIG. 5. For example, the duct 28 may be elongated from the first end 54 to the second end 56. That is, the longest dimension of the duct 28 may be from the first end 54 to the second end 56. The duct 28 defines a flow path from the first end 54 to the second end 56. A cross-sectional area of the duct 28 normal to the flow path may, for example, be uniform from the first end 54 to the second end 56 of the duct 28, e.g., to maintain a speed of the air flowing through the duct 28. As another example, the cross-sectional area may vary between the first and second ends 56, e.g., to change the speed of the air flowing through the duct 28.

With reference to FIG. 5, the first end 54 of the duct 28 is coupled to the blower 20, e.g., the exhaust. Specifically, the first end 54 of the duct 28 is fluidly connected to the blower 20 such that air exhausted by the blower 20 enters the duct 28. The duct 28 extends in a departure direction D away from the blower 20 at the first end 54. In other words, the first end 54 of the duct 28 changes a direction of air exhausted by the blower 20 from the flow direction F to the departure direction D. The departure direction D extends generally from the blower 20 towards the sensor 22. The departure direction D is oblique to the flow direction F. In an example in which the flow direction F is along the lateral axis A₂, the departure direction D may extend along the longitudinal axis A₁ and/or the vertical axis A₃. In an example in which the flow direction F is along the longitudinal axis A₁, the departure direction D may extend along the lateral axis A₂ and/or the vertical axis A₃. The departure direction D may define any suitable angle with the flow direction F, e.g., with respect to a three-dimensional (3D) coordinate system, e.g., a Cartesian coordinate system, having an origin at the blower 20, such that the duct 28 satisfies packing constraints while minimizing flow loss through the duct 28.

With continued reference to FIG. 5, the second end 56 of the duct 28 is coupled to the air nozzle 26. Specifically, the second end 56 of the duct 28 is fluidly connected to the air nozzle 26 such that air exhausted by the duct 28 enters the air nozzle 26. The duct 28 may extend in an approach direction B toward the lens 24 at the second end 56. The approach direction B may be oblique to the flow direction F. As one example, the approach direction B may be oblique to the departure direction D as well as the flow direction F. As another example, the approach direction B may be parallel to the departure direction D. The approach direction B may define any suitable angle with the flow direction F and the departure direction D, e.g., with respect to the 3D coordinate system, such that the duct 28 satisfies packing constraints while minimizing flow loss through the duct 28.

The sensor assembly 12 may include a same number of ducts 28 as sensors 22. The sensors 22 may be spaced from each other within the chamber 16 such that each duct 28 extends toward one respective sensor 22. In an example in which two ducts 28a, 28b are coupled to one blower 20, as shown in FIG. 5, the ducts 28a, 28b extend in respective departure directions Dₐ, D_{b} away from the blower 20. The departure directions Dₐ, D_{b} extend transverse to each other and oblique to the flow direction F. Additionally, in such an example, the ducts 28a, 28b extend in respective approach directions Bₐ, B_{b} to direct air across respective sensors 22 spaced from each other.

Returning to FIG. 2, the sensor assembly 12 includes the sensors 22 and the scanning sensor 30. The sensors 22 may detect the location and/or orientation of the vehicle 10. For example, the sensors 22 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 22 may detect the external world, e.g., objects and/or characteristics of surroundings of the vehicle 10, such as other vehicles 10, road lane markings, traffic lights and/or signs, pedestrians, etc. For example, the sensors 22 may include radar sensors, scanning laser range finders, light detection and ranging (LIDAR) devices, and image processing sensors such as cameras. The sensors 22 may include communications devices, for example, vehicle-to-infrastructure (V2I) or vehicle-to-vehicle 10 (V2V) devices.

The scanning sensor 30 may be disposed outside the housing 14. The scanning sensor 30 protrudes upward from the housing upper piece 36, as shown in FIGS. 1-3. The scanning sensor 30 may be a camera, a LIDAR device, a radar sensor, etc. The scanning sensor 30 is disposed above the housing lower piece 38 to have an unobstructed 360° horizontal field of view. For example, the scanning sensor 30 may be supported by the housing upper piece 36. In this situation, the scanning sensor 30 may extend at least partially through the housing upper piece 36 into the chamber 16, e.g., via the central opening 40. The scanning sensor 30 may be fixed relative to the housing upper piece 36 in the chamber 16, e.g., via fasteners, clips, etc. The scanning sensor 30 may be positioned laterally, i.e., along a left-right dimension relative to the vehicle 10, in a middle of the vehicle 10. The scanning sensor 30 may have a cylindrical shape defining an axis (not shown) that is oriented substantially vertically.

With continued reference to FIG. 2, the sensors 22 may be disposed in the housing 14, specifically in the chamber 16. The sensors 22 may be attached directly to the body panel 34 in the chamber 16, or the sensors 22 may be attached to the housing lower piece 38 in the chamber 16, which in turn is directly attached to the roof. The sensors 22 may be cameras arranged to collectively cover a 360° field of view with respect to a horizontal plane. Each sensor 22 has a field of view through the respective lens 24 and the respective aperture 42, and the field of view of one sensor 22 may overlap the fields of view of the sensors 22 that are circumferentially adjacent to one another, i.e., that are immediately next to each other.

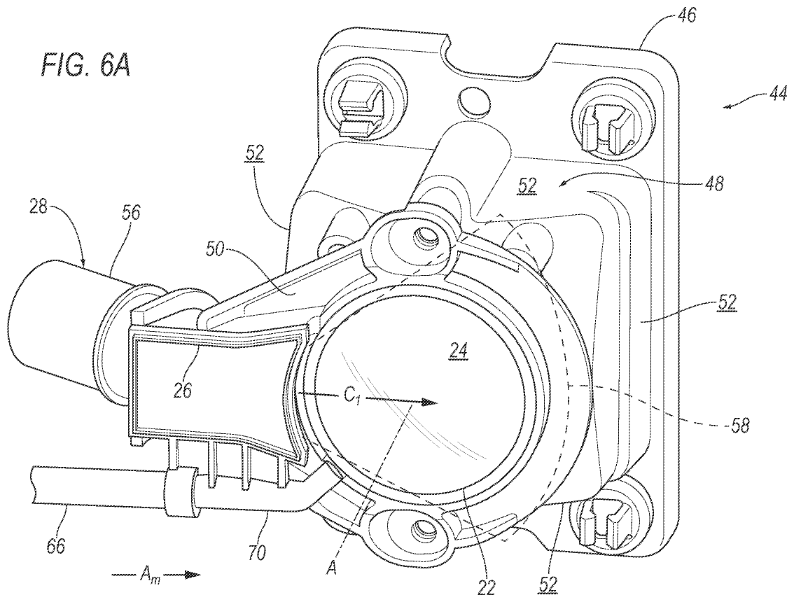

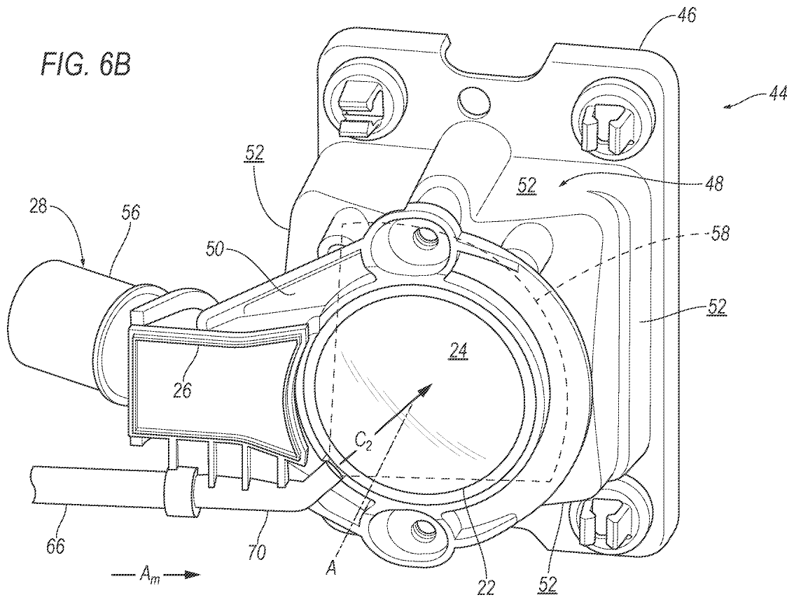

With reference to FIGS. 6A and 6B, the sensors 22 include respective lenses 24. Each lens 24 may define the field of view of the respective sensor 22 through the aperture 42. Each lens 24 may be convex. Each lens 24 defines an axis A, around which the lens 24 is radially symmetric. The axis A extends along a center of the field of view of the respective sensor 22.

The sensor assembly 12 may include a plurality of casings 44. Each casing 44 may be disposed in the chamber 16 and mounted to one respective sensor 22. The casing 44 extends completely around the sensor 22. That is, the casing 44 shields the sensor 22 from the chamber 16.

With continued reference to FIGS. 6A and 6B, each casing 44 may include a base portion 46, a tunnel portion 48, and a top panel 50. The tunnel portion 48 extends circumferentially around the axis A. For example, the tunnel portion 48 can include a plurality of flat panels 52, e.g., four flat panels 52, connected together in a circumferential loop around the axis A. The top panel 50 extends parallel to the lens 24, i.e., orthogonal to the axis A defined by the lens 24. The base portion 46 extends radially outward from the tunnel portion 48 relative to the axis A, and the top panel 50 extends radially inward from the tunnel relative to the axis A. The top panel 50 and the base portion 46 can be parallel to each other.

The casing 44 is attached to the sensor 22. Specifically, the base portion 46 of the casing 44 is attached to the sensor 22, and the rest of the casing 44 is not attached to the sensor 22, as shown in FIG. 5. The base portion 46 is attached to the sensor 22 in any suitable manner, e.g., clips, fasteners, adhesive, etc. The tunnel portion 48 and the top panel 50 hang from the base portion 46 and extend around the lens 24 without being attached directly to the sensor 22 or the lens 24. This arrangement reduces vibrations experienced by the sensor 22.

With reference to FIG. 6A, the air nozzle 26 may be mounted to the casing 44, specifically to the top panel 50. For example, the top panel 50 may include an overhanging portion extending radially outside the tunnel portion 48 relative to the axis A. The air nozzle 26 may be attached to the overhanging portion in any suitable manner, e.g., clips, fasteners, adhesive, etc.

The air nozzle 26 is aimed across and at the lens 24 so that air strikes the lens 24 at a shallow angle, e.g., less than 10°. Additionally, the air nozzle 26 may be aimed so that a direction of airflow from the air nozzle 26 is generally parallel to an ambient airflow Aₘ during forward motion of the vehicle 10. That is, the air nozzles 26 may be aimed to direct airflow in various directions, e.g., based on a position of a respective sensor 22 relative to the vehicle 10. As used herein, “generally parallel” means that a horizontal component of the airflow from the air nozzle 26 is parallel to the ambient airflow Aₘ during forward motion of the vehicle 10, even if the airflow from the air nozzle 26 has a vertical component that is transverse to the ambient airflow Aₘ. This arrangement can help minimize interference of the airflow from the air nozzle 26 by the ambient airflow Aₘ during forward motion of the vehicle 10.

With continued reference to FIG. 6A, the air nozzle 26 may be shaped to discharge air in a flat-fan pattern 58. For the purposes of this disclosure, a “flat-fan pattern” means that the discharge has an increasing width in one dimension as the discharge moves away from the air nozzle 26 and has a generally flat shape along a plane defined by the width and a direction of discharge C₁. The direction of discharge C₁ is directed along a center of the spray pattern, i.e., bisecting the flat-fan pattern 58. The direction of discharge C₁ of the air nozzle 26 is in a radially inward direction with respect to the axis A, i.e., a direction that is toward the axis A.

The spray pattern may cause the airflow from the air nozzle 26 to form an air curtain across the lens 24. For the purposes of this disclosure, an “air curtain” means a layer of moving air that has a width significantly greater than a thickness, that is close to a surface, and that is moving generally parallel to the surface. An air curtain can, for example, remove debris from the lens 24 as well as prevent debris from contacting the lens 24. As another example, the air curtain can dry, defog, and/or defrost the lens 24.

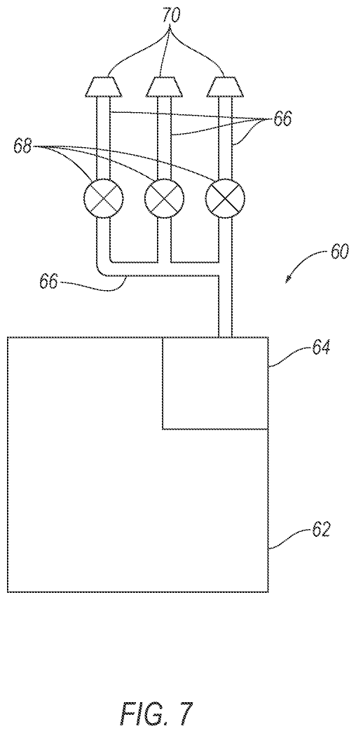

Turning now to FIG. 7, the vehicle 10 may include a liquid cleaning system 60. The liquid cleaning system 60 may include a reservoir 62, a pump 64, supply lines 66, valves 68, and fluid nozzles 70. The reservoir 62 and the pump 64 are fluidly connected (i.e., fluid can flow from one to the other) to each valve 68 and to each the fluid nozzle 70. The liquid cleaning system 60 distributes washer fluid stored in the reservoir 62 to the fluid nozzles 70. “Washer fluid” refers to any liquid stored in the reservoir 62 for cleaning. The washer fluid may include solvents, detergents, diluents such as water, etc.

The reservoir 62 may be a tank fillable with liquid, e.g., washer fluid for window cleaning. The reservoir 62 may be disposed in a front of the vehicle 10, specifically, in an engine compartment forward of a passenger cabin. Alternatively, the reservoir 62 may be disposed in the housing 14, e.g., in the chamber 16. The reservoir 62 may store the washer fluid only for supplying the sensor assembly 12 or also for other purposes, such as supply to the windshield.

The pump 64 forces the washer fluid through the supply lines 66 to the valves 68 and then to the fluid nozzles 70 with sufficient pressure that the washer fluid sprays from the fluid nozzles 70. The pump 64 is fluidly connected to the reservoir 62. The pump 64 may, for example, be attached to or disposed in the reservoir 62.

The supply lines 66 can extend from the pump 64 to the valves 68, and from the valves 68 to the fluid nozzles 70. A separate supply line 66 extends from each valve 68 to the respective fluid nozzle 70. The supply lines 66 may be, e.g., flexible tubes.

The valves 68 are independently actuatable to open and close, to permit the washer fluid to flow through or to block the washer fluid; i.e., each valve 68 can be opened or closed without changing the status of the other valves 68. Each valve 68 is positioned to permit or block flow from the reservoir 62 to a respective one of the fluid nozzles 70. The valves 68 may be any suitable type of valve, e.g., ball valve, butterfly valve, choke valve, gate valve, globe valve, etc.

Returning to FIG. 6B, the fluid nozzles 70 may maintain clarity of a field-of-view of a respective sensor 22, e.g., liquid exiting the fluid nozzles 70 may clean the lenses 24 of the sensors 22. Each fluid nozzle 70 may be mounted to one respective casing 44, specifically to the top panel 50, e.g., the overhanging portion. The fluid nozzle 70 may be attached to the overhanging portion, e.g., in substantially the same manner as the air nozzle 26.

The fluid nozzle 70 is aimed across and at the lens 24 so that fluid strikes the lens 24 at a shallow angle, e.g., less than 10°. That is, the fluid nozzle 70 is aimed to direct fluid across the lens 24. Additionally, the fluid nozzle 70 may be aimed so that a direction of fluid from the fluid nozzle 70 is generally parallel to the ambient airflow Aₘ during forward motion of the vehicle 10. This arrangement can help minimize interference of the fluid by the ambient airflow Aₘ during forward motion of the vehicle 10.

With continued reference to FIG. 6B, the fluid nozzle 70 may be shaped to spray fluid in the flat-fan pattern 58. The fluid nozzle 70 has a direction of discharge C₂ directed along a center of the spray pattern, i.e., bisecting the flat-fan pattern 58. The direction of discharge C₂ of the fluid nozzle 70 is in a radially inward direction with respect to the axis A, i.e., a direction that is toward the axis A.

The direction of discharge C₂ of the fluid nozzle 70 is different than, i.e., transverse to, the direction of discharge C₁ of the air nozzle 26. For example, the fluid nozzle 70 may be circumferentially spaced from the air nozzle 26 about the axis A. As one example, the fluid nozzle 70 may be oblique to the air nozzle 26. This arrangement may assist in positioning the fluid nozzle 70 such that the fluid nozzle 70 does not interfere with the airflow from the air nozzle 26 and that sprayed fluid can contact the lens 24 at the desired shallow angle.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance or order. Many modifications and variations of the present disclosure are possible in light of the above teachings, and the disclosure may be practiced otherwise than as specifically described.

1. A sensor assembly, comprising:
a housing defining a chamber and having an air inlet;
a blower disposed in the chamber and in fluid communication with the air inlet, the blower being positioned to direct air in a flow direction;
a sensor disposed in the chamber and having a lens, the sensor being spaced from the blower;
an air nozzle aimed to direct air across the lens; and
a duct disposed in the chamber and being coupled to the blower and the air nozzle, the duct extending from the blower in a departure direction oblique to the flow direction.

2. The sensor assembly of claim 1, further comprising a fluid nozzle aimed to direct fluid across the lens.

3. The sensor assembly of claim 2, wherein the fluid nozzle is circumferentially spaced from the air nozzle about the lens.

4. The sensor assembly of claim 2, wherein the fluid nozzle is oblique to the air nozzle.

5. The sensor assembly of claim 2, wherein the fluid nozzle is shaped to spray fluid in a flat-fan pattern.

6. The sensor assembly of claim 5, wherein the air nozzle is shaped to discharge air in a flat-fan pattern.

7. The sensor assembly of claim 1, wherein the air nozzle is shaped to discharge air in a flat-fan pattern.

8. The sensor assembly of claim 1, wherein the duct extends transverse to the flow direction at the nozzle.

9. The sensor assembly of claim 1, further comprising:
a second sensor disposed in the chamber and having a second lens, the second sensor being spaced from the sensor and the blower;
a second air nozzle aimed to direct air across the second lens; and
a second duct disposed in the chamber and extending from the blower to the second air nozzle, the second duct being coupled to the blower and the second air nozzle.

10. The sensor assembly of claim 9, wherein the second duct extends from the blower in a second departure direction oblique to the flow direction and transverse to the departure direction.

11. A vehicle, comprising:
a roof;
a housing supported by the roof, the housing defining a chamber and having an air inlet;
a blower disposed in the chamber and in fluid communication with the air inlet, the blower being positioned to direct air in a flow direction;
a sensor disposed in the chamber and having a lens, the sensor being spaced from the blower;
an air nozzle aimed to direct air across the lens; and
a duct disposed in the chamber and being coupled to the blower and the air nozzle, the duct extending from the blower in a departure direction oblique to the flow direction.

12. The vehicle of claim 11, further comprising a fluid nozzle aimed to direct fluid across the lens.

13. The vehicle of claim 12, wherein the fluid nozzle is circumferentially spaced from the air nozzle about the lens.

14. The vehicle of claim 12, wherein the fluid nozzle is oblique to the air nozzle.

15. The vehicle of claim 12, wherein the fluid nozzle is aimed to direct fluid generally parallel to ambient airflow during forward motion of the vehicle.

16. The vehicle of claim 15, wherein the air nozzle is aimed to direct air generally parallel to ambient airflow during forward motion of the vehicle.

17. The vehicle of claim 11, wherein the air nozzle is aimed to direct air generally parallel to ambient airflow during forward motion of the vehicle.

18. The vehicle of claim 11, wherein the duct extends transverse to the flow direction at the nozzle.

19. The vehicle of claim 11, further comprising:
a second sensor disposed in the chamber and having a second lens, the second sensor being spaced from the sensor and the blower;
a second air nozzle aimed to direct air across the second lens; and
a second duct disposed in the chamber and extending from the blower to the second air nozzle, the second duct being coupled to the blower and the second air nozzle.

20. The vehicle of claim 19, wherein the second duct extends from the blower in a second departure direction oblique to the flow direction and transverse to the departure direction.
